(19) United States
(12) Patent Application Publication
(10) Pub. No.: US 2003/0217627 A1
(43) Pub. Date: Nov. 27, 2003

(54) Sheet delivery apparatus

(75) Inventor: Tsunetoshi Teshima, Yamato-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TOKYO KIKAI SEISAKUSHO, LTD., Tokyo (JP)

(21) Appl. No.: 10/361,482

(22) Filed: Feb. 11, 2003

(30) Foreign Application Priority Data
May 23, 2002 (JP) JP2002-148550

(51) Int. Cl. B26D 7/06

(52) U.S. Cl. 83/409

(57) ABSTRACT

In a sheet delivery apparatus of a sheet folding machine for a rotary printing press, a cutter mechanism cuts a continuous paper web traveling along a paper web path into sheets. A first conveyor, disposed downstream of the cutter mechanism, conveys the sheets successively with spaces therebetween. A second conveyor, disposed adjacent to and downstream of the first conveyor and having a carrying surface lower in level than the carrying surface of the first conveyor, receives the sheets transferred successively from the first conveyor, and conveys the sheets at a conveying speed lower than that of the first conveyor after arranging the sheets in a scale-like train. A pushing down device, disposed adjacent to an upstream end of the second conveyor, pushes downward against the second conveyor a trailing end portion of the individual sheet being transferred from the first conveyor to the second conveyor. A paper pressing device guides a leading end of the succeeding sheet transferred from the first conveyor to the second conveyor, and presses the leading end of the succeeding sheet downward; i.e., toward the second conveyor.

### BACKGROUND OF THE INVENTION

1. Field of the Invention

The present invention relates to a sheet delivery apparatus to be incorporated in a processing machine in which a continuous paper web is processed while being drawn from a paper roll.

2. Description of the Related Art

Japanese Patent No. 2788238 and Japanese Utility Model Application Laid-Open No. Hei 03-044154 exemplify sheet delivery apparatuses of conventional processing machines in which a continuous paper web is processed while being drawn from a paper roll.

The sheet delivery apparatus disclosed in Japanese Patent No. 2788238 comprises a cutter mechanism disposed in a branch paper web path branched from a paper web path between a former and a group of folding drums, for cutting a continuous paper web into sheets; a first conveyor disposed downstream of the cutter mechanism for conveying the sheets successively at a conveying speed slightly higher-than the drum circumferential speed of the cutter mechanism; a second conveyor disposed downstream of the first conveyor for further conveying the successive sheets at a conveying speed slower than the conveying speed of the first conveyor; and a braking roller disposed above the upstream end of the first conveyor and vertically movable toward and away from the second conveyor in synchronism with the conveying of the successive sheets.

In the above-mentioned conventional sheet delivery apparatus, when a succeeding sheet cut by the cutter mechanism is transferred from the first conveyor to the second conveyor, the braking roller is lowered to push downward against the second conveyor the trailing end portion of a preceding sheet transferred onto the second conveyor, so as to reduce the traveling speed of the preceding sheet to the conveying speed of the second conveyor. Subsequently, by the time the leading end of the succeeding sheet arrives at the upstream end of the second conveyor, the braking roller is raised away from the second conveyor so as not to block the advancing of the succeeding sheet, thereby allowing the succeeding sheet to advance onto the preceding sheet in such a manner that the successive sheet partially overlaps the preceding sheet to form a scale-like train.

As the foregoing operation is repeated, the sheets are conveyed successively on the second conveyor and arranged in a scale-like train.

Meanwhile, the conventional sheet delivery apparatus disclosed in Japanese Utility Model Application Laid-Open No. Hei 03-044154 comprises a cutter mechanism for cutting sheets off a continuous paper web folded onto itself by a former; a first conveyor disposed downstream of the cutter mechanism for conveying the sheets successively at a conveying speed greater than the circumferential speed of cutting drums of the cutter mechanism; a second conveyor disposed downstream of the first conveyor for further conveying the sheets successively at a conveying speed lower than the conveying speed of the first conveyor; a pushing down device disposed above the upstream end of the second conveyor for pushing downward onto the second conveyor a sheet being transferred from the first conveyor to the second conveyor; a speed reduction pulley disposed downstream of the pushing down device and having a stepped portion on its circumferential surface, for receiving the leading end of the sheet transferred onto the second conveyor by the stepped portion and decreasing the traveling speed of the received sheet within a predetermined region in a sheet path; and a braking roller disposed downstream of the speed reduction pulley for acting on the sheet whose traveling speed is reduced by the pushing down device, in such a manner that the sheet is advanced at a traveling speed equal to the conveying speed of the second conveyor.

However, the conventional technology disclosed in Japanese Patent No. 2788238 encounters the following problem.

When the succeeding sheet being conveyed by the first conveyor at a traveling speed greater than that of the preceding sheet being conveyed by the second conveyor is advanced and overlaps the preceding sheet, the braking roller having been lowered to push the preceding sheet downwardly is raised so that the preceding sheet tends to displace freely. Therefore, with continued advancing of the succeeding sheet, the preceding sheet is prone to be pushed forward or bent by the succeeding sheet as a result of the friction at the interface between these two sheets, causing a staggered pitch of overlapping of the successive sheets.

In the meantime, the conventional technology disclosed in Japanese Utility Model Application Laid-Open No. Hei 03-044154 involves the following problem.

After the succeeding sheet being conveyed by the first conveyor at a speed greater than that of the preceding sheet being conveyed by the second conveyor is released from the speed-decreasing action of the reduction pulley and until it undergoes the action of the braking roller, the succeeding sheet is advanced while overlapping the preceding sheet. Therefore, as in the case of the first-named conventional technology, with continued advancing of the succeeding sheet, the preceding sheet is prone to being pushed forward or bent by the succeeding sheet as a result of the friction at the interface between these two sheets, causing a staggered pitch of overlapping of the successive sheets.

Further, the sheet delivery apparatus is complex in mechanical construction and large in size, since the reduction pulley and the braking roller, which is disposed downstream of the reduction pulley, are essential for arranging the successive sheets being transferred from the first conveyor to the second conveyor, in a scale-like train on the second conveyor.

As described above, in either of these two conventional technologies, the pitch of overlapping of the successive sheets tends to become non-uniform, which raises inconveniences, such as inaccurate counting and sheet jamming, in a subsequent machine; e.g., a binding machine, and occasionally deteriorates product quality. Additionally, the mechanical complexity of the apparatus increases the operator's labor for maintenance and inspection work, and the large size of the apparatus constitutes an obstacle against space savings.

### SUMMARY OF THE INVENTION

In view of the foregoing problems involved in the conventional art, an object of the present invention is to provide a sheet delivery apparatus of a sheet folding machine, which apparatus can convey sheets in a scale-like train without any irregular variation in pitch of overlapping and which has a simple mechanical construction so as to reduce the operator's labor for maintenance and inspection work and enhance space savings.

To attain the above-described object, the present invention provides a sheet delivery apparatus comprising: (a) a cutter mechanism for cutting a continuous paper web traveling in a paper web path transversely into sheets of a predetermined length; (b) a first conveyor disposed downstream of the cutter mechanism and adapted to convey the sheets successively with spaces therebetween; (c) a second conveyor disposed adjacent to and downstream of the first conveyor and having a carrying surface lower in level than the carrying surface of the first conveyor, the second conveyor receiving the sheets transferred successively from the first conveyor and conveying the sheets at a conveying speed lower than that of the first conveyor after arranging the sheets in a scale-like train in which a succeeding sheet partially overlaps a preceding sheet; (d) a pushing down device disposed adjacent to an upstream end of the second conveyor and adapted to push downward against the second conveyor a trailing end portion of the individual sheet being transferred from the first conveyor to the second conveyor; and (e) a paper pressing device disposed above the second conveyor so as to face the carrying surface thereof in a position spaced from a downstream end of the carrying surface of the first conveyor by a distance substantially equal to the predetermined length of the sheet, the paper pressing device guiding a leading end portion of the succeeding sheet transferred from the first conveyor to the second conveyor and pressing downward the leading end portion of the succeeding sheet overlapping the preceding sheet carried on the carrying surface of the second conveyor.

Preferably, the pushing down device is a revolving member whose phase of rotation is adjustable by a phase adjustment mechanism, and the paper pressing device is a pulley facing a guide plate with a belt of the second conveyor interposed between the pulley and the guide plate.

### BRIEF DESCRIPTION OF THE DRAWINGS

Various other objects, features, and many of the attendant advantages of the present invention will be readily appreciated as the same becomes better understood by reference to the following detailed description of the preferred embodiment when considered in connection with the accompanying drawings, in which:

FIG. 1 is a schematic view of a sheet folding machine equipped with a sheet delivery apparatus according to an embodiment of the present invention;

FIG. 2 is a schematic view showing the sheet delivery apparatus of the present embodiment;

FIG. 3 is an enlarged side view, partially in cross section, of a pushing down device and a phase adjustment mechanism of the pushing down device shown in FIG. 2;

FIG. 4 is a plan view taken along line IV-IV of FIG. 3;

FIG. 5 is an enlarged side view, partially in cross section, of a second conveyor and a paper pressing device of FIG. 2;

FIG. 6 is a plan view taken along line VI-VI of FIG. 5;

FIGS. 7A and 7B illustrate the first half of the operation of the paper pressing device and pushing down device;

FIGS. 8A and 8B illustrate the second half of the operation of the paper pressing device and pushing down device; and

FIG. 9 is an explanatory view showing the paper pressing device and the second conveyor while in a standby status.

### DESCRIPTION OF THE PREFERRED EMBODIMENT

A sheet delivery apparatus of a sheet folding machine according to a preferred embodiment of the present invention will now be described with reference to the accompanying drawings.

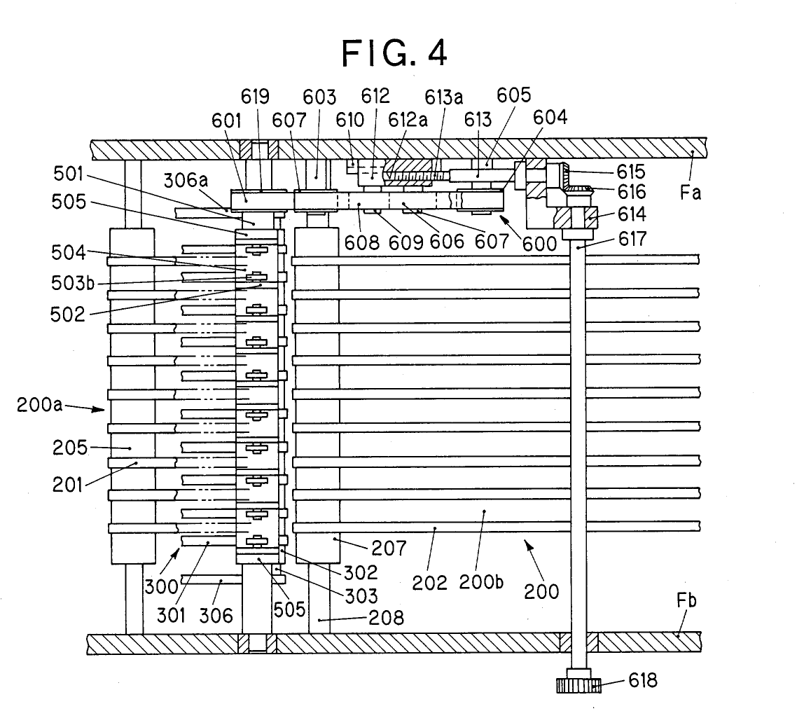

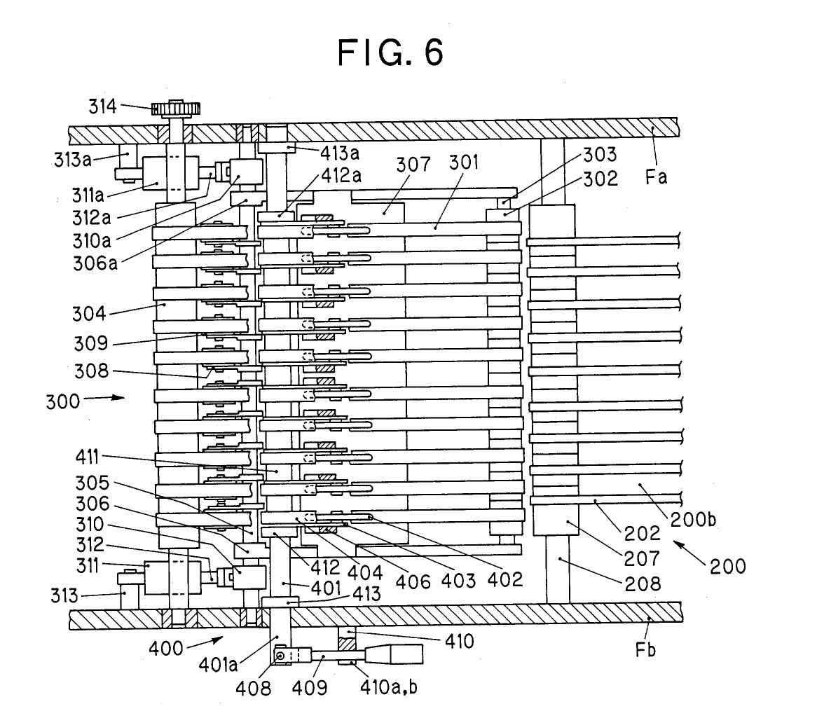

In the following description, “the up-down direction” and “the right-left direction” are used to denote the vertical direction and the horizontal direction, respectively, in connection with several figures of the accompanying drawings except plan views; i.e., FIGS. 4 and 6.

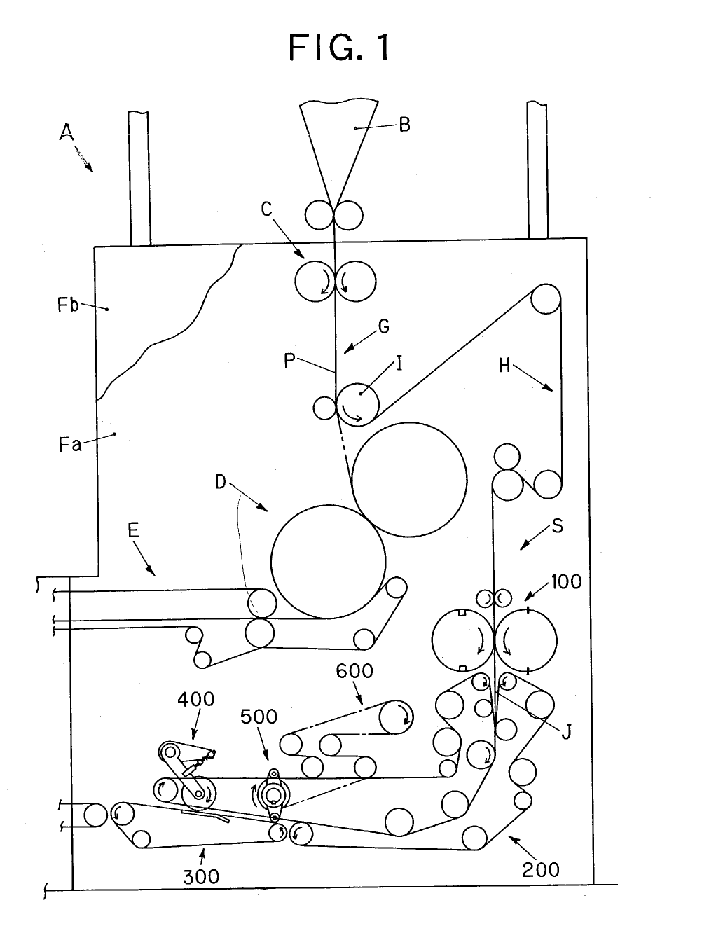

First, a sheet folding machine of a rotary printing press of the type in which printing takes place on a continuous paper web drawn from a paper roll is shown in FIG. 1 as an example of a processing machine in which the sheet delivery apparatus of the present embodiment is incorporated.

In FIG. 1, as a sheet folding machine A operates, a continuous paper web P having traveled through an unillustrated printing station and then folded in half about the longitudinal centerline by a former B is drawn and fed downward by a pair of nipping rollers C supported between and by two frames Fa, Fb. Subsequently, the two-fold continuous paper web P is threaded through a folding drum group D along a paper web path G, whereby the two-fold continuous paper web P is cut into two-fold sheets of a predetermined length, and each of the two-fold sheets is further folded into a four-fold sheet. The four-fold sheet is conveyed downstream to a selectively operable chopper folding device (not shown) by a conveyor E. With or without being processed by the chopper folding device, the successive four-fold sheets are then transferred onto an unillustrated downstream-most conveyor via an unillustrated delivery fan disposed downstream of the chopper folding device, in a scale-like arrangement in which a succeeding four-fold sheet partially overlaps a preceding four-fold sheet. Finally, the successive four-fold sheets are discharged out of the sheet folding machine A in a scale-like train as carried by the unillustrated downstream-most conveyor.

In the paper web path G between the pair of nipping rollers C and the folding drum group D disposed downstream of the former B, there is disposed a guide roller I by which the paper web path G branches off as a paper web path branch H. The paper path branch H extends from the guide roller I in a direction opposite (rightward in FIG. 1) the conveyor E with respect to the folding drum group D and then leads downward of the folding drum group D and also downward of the conveyor E.

As shown in the example of FIG. 1, a sheet delivery apparatus S of the present embodiment is disposed along the paper web path branch H in the sheet folding machine A.

The sheet delivery apparatus S comprises (a) a cutter mechanism 100 for cutting the continuous paper web P traveling along the paper web path branch H, transversely into sheets J of predetermined length; (b) a first conveyor 200 disposed downstream of the cutter mechanism 100 and adapted to convey the sheets J successively with spaces therebetween; (c) a second conveyor 300 disposed downstream of the first conveyor 200 and adapted to receive the sheets J transferred successively from the first conveyor 200, arrange the sheets J in a scale-like arrangement in which a succeeding sheet partially overlaps a preceding sheet, and convey the sheets J as a scale-like train; (d) a paper pressing device 400 disposed upwardly of the second conveyor 300 and adapted to catch a leading end portion of a sheet J being transferred from the first conveyor 200 to the second conveyor 300 at a predetermined position, guide the caught sheet J onto the preceding sheet J with the leading edge of the succeeding sheet J set back or behind that of the preceding sheet J, by rotation, and press downward toward the second conveyor 300 the overlapped sheets J carried by the second conveyor 300; (e) a pushing down device 500 disposed adjacent to an upstream end of the second conveyor 300 and upstream of the paper pressing device 400 and adapted to push downward against the second conveyor 300 a trailing end portion of a sheet J being transferred from the first conveyor 200 to the second conveyor 300, when the trailing end portion passes the above-described predetermined position; and (f) a phase adjustment mechanism 600 disposed in a drive path used for driving the pushing down device 500 and capable of adjusting the rotational phase of the pushing down device 500 during operation.

These individual components (a) through (f) of the sheet delivery apparatus S will now be described in detail:

(a) Cutter Mechanism 100

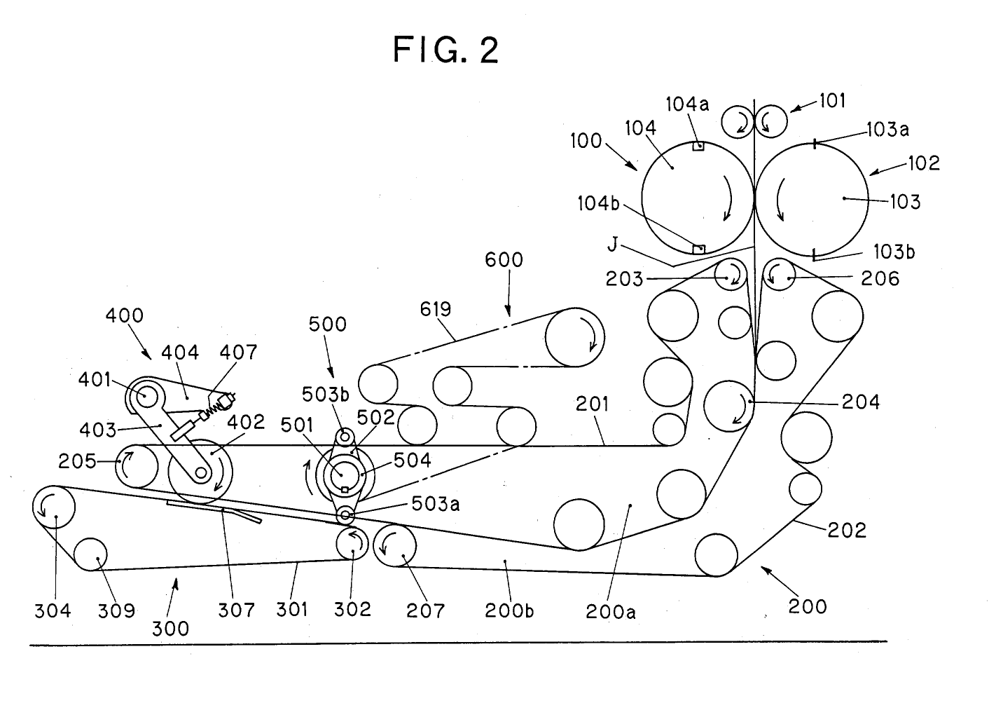

The cutter mechanism 100 is located in the paper web path branch H as shown in FIG. 1, and comprises a pair of paper web feed rollers 101 and a pair of cutting drums 102, each pair being disposed so as to sandwich the continuous paper web H traveling along the paper web path branch H, as shown in FIG. 2.

The paper web feed rollers 101, whose shafts are rotatably supported at their opposite ends by the two frames Fa, Fb, are driven by an unillustrated drive unit for rotation in the directions indicated by arrows in FIG. 2, in order to feed the continuous paper web P downstream while nipping the continuous paper web P with a proper pressure. The pair of cutting drums 102 are disposed immediately downstream of the pair of paper web feed rollers 101.

One of the cutting drums 102 is a cutter-blade carrying drum 103, on a circumferential surface of which two cutter blades 103a, 103b are mounted at diametrically opposite positions, the cutter blades 103a, 103b extending parallel to the axis of the drum 103 and projecting radially outward from the circumferential surface. The other cutting drum 102 is a cutting-shoulder carrying drum 104, on a circumferential surface of which two cutting shoulders 104a, 104b are mounted for receiving the respective cutter blades 103a, 103b of the cutter-blade carrying drum 103. The cutter-blade carrying drum 103 and the cutting-shoulder carrying drum 104, whose shafts are rotatably supported at their opposite ends by the two frames Fa, Fb, are driven by an unillustrated drive unit for rotation in the directions indicated by arrows in FIG. 2.

The circumferential surface of the cutter-blade carrying drum 103 and that of the cutting-shoulder carrying drum 104 face each other with a gap therebetween for passage of the continuous paper web P. As these drums 103, 104 rotate in the directions indicated by arrows in FIG. 2, the cutter blades 103a, 103b of the cutter-blade carrying drum 103, bite, one at a time, into the corresponding cutting shoulders 104a, 104b of the cutting-shoulder carrying drum 104 at the tangential position of the two drums 103, 104.

Accordingly, the continuous paper web P is cut transversely into sheets J of predetermined length as it passes through the gap between the pair of cutting drums 102 rotating at a circumferential speed corresponding to the traveling speed of the continuous paper web P.

(b) First Conveyor 200

The first conveyor 200 is disposed downstream of the cutter mechanism 100 and extends under and around the folding drum group D, as shown in FIGS. 1 and 2. The first conveyor 200, as shown in FIG. 2, is composed of an upper conveyor 200a in which a plurality of endless flat belts 201 are wound around three rollers 203, 204, 205 with axial spaces, which rollers are rotatably supported by the two frames Fa, Fb; and a lower conveyor 200b in which a plurality of endless flat belts 202 are wound around two rollers 206, 207 with axial spaces, which rollers are rotatably supported by the two frames Fa, Fb. The pitch of axial arrangement of the flat belts 201 of the upper conveyor 200a is identical with that of the flat belts 202 of the lower conveyor 200b.

The rollers 203, 206 are disposed downward of the pair of cutting drums 102 and are horizontally spaced from each other, and the roller 204 is disposed downward of these two rollers 203, 206.

Portions of the flat belts 201 wounded around and extending from the roller 203 in the downstream direction and portions of the flat belts 202 wounded around and extending from the roller 206 in the downstream direction form a space therebetween in such a manner that the space gradually narrows; and these portions of the flat belts 201 and 202 are then wound on the circumferential surface of the roller 204, thus serving as a hopper for temporarily receiving the successive sheets J one at a time.

At a position immediately upstream of the roller 204, the flat belts 201 and the flat belts 202 sandwich the sheet J cut by the cutter mechanism 100 and convey that sheet J first vertically and then substantially horizontally.

Further, the upper and lower conveyors 200a, 200b are driven by an unillustrated drive unit at a conveying speed that is proportional to and slightly higher than the circumferential speed of the paper web feed rollers 101 and cutting drums 102 of the cutter mechanism 100.

At a downstream portion of the first conveyor 200, the roller 205 of the upper conveyor 200a is disposed downstream of the downstream-most roller 207 of the lower conveyor 200b; i.e., upward of the flat belts 301 of the second conveyor 300 with the flat belts 201 gently sloping upward toward the roller 205 (i.e., toward the downstream side).

(c) Second Conveyor 300

The second conveyor 300 is disposed downstream of the lower conveyor 200b of the first conveyor 200 and extends under the upper conveyor 200a of the first conveyor 200, as shown in FIG. 2.

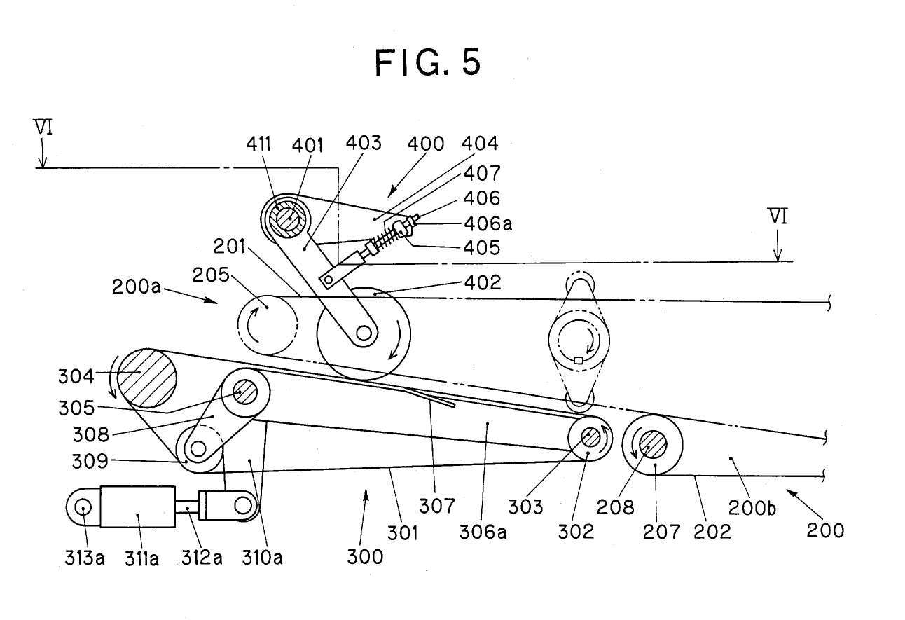

As shown in FIGS. 5 and 6, at a position downstream of the roller 205 of the upper conveyor 200a of the first conveyor 200, a shaft 305 is rotatably supported at its opposite ends by the two frames Fa, Fb.

The base end of an arm 310a is fixedly attached to the shaft 305 in the vicinity of and inward of the frame Fa; and the base end of an arm 310 is fixedly attached to the shaft 305 in the vicinity of and inward of the frame Fb. Also, the base ends of two arms 306, 306a are fixedly attached to the shaft 305 to be located inward of the arms 310, 310a, respectively.

Further, a plurality of (in equal number to the belts of the second conveyor 300) arms 308 are fixedly attached to the shaft 305 with axial spaces to be located inward of the arms 306, 306a.

Further, the distal ends of the downward extending arms 310, 310a are pivotably attached to the respective distal ends of two rods 312, 312a projecting from the respective distal ends of two hydraulic cylinders 311, 311a, whose base ends are pivotably attached to two pins 313, 313a, respectively, on the respective inner surfaces of the two frames Fa, Fb.

A shaft 303 is attached at its opposite ends to the distal ends of the two arms 306, 306a, which extend from the shaft 305 in the upstream direction. A roller 302, which is axially divided into a plurality of roller sections, is rotatably mounted on the shaft 303 adjacent to and downstream of the downstream roller 207 of the lower conveyor 200b of the first conveyor 200.

At a position downstream of the shaft 305 (leftward of the shaft 305 in FIG. 5), the shaft of a drive roller 304 is rotatably supported at its opposite ends by the two frames Fa, Fb. One end of the last-named shaft projects outward from the frame Fa. A gear 314 is mounted on the projecting end of the shaft of the drive roller 304, and is meshed with an unillustrated gear operatively connected with an unillustrated drive unit.

Further, a tension roller 309 is rotatably attached to the distal ends of the plurality of arms 308.

The second conveyor 300, in which a plurality of endless flat belts 301 are wound around the roller 302, the drive roller 304, and the tension rollers 309 with axial spaces, is driven by an unillustrated drive unit at a conveying speed slower than the conveying speed of the first conveyor 200 so as to maintain a constant conveying speed ratio with respect to the conveying speed of the first conveyor 200.

The surface of a top portion of the roller 302 is slightly lower than the surface of a top portion of the roller 207 of the first conveyor 200, which roller is disposed adjacent to and upstream of the roller 302, in such a manner that upper portions of the flat belts 301 extending between the roller 302 and the drive roller 304 are spaced parallel to and away from lower portions of the flat belts 201 of the first conveyor 200, which is disposed above the second conveyor 300.

As shown in FIG. 5, under the upper portions of the flat belts 301 extending between the roller 302 and the drive roller 304, there is provided a guide plate 307 whose one end is attached to the two arms 306, 306a.

(d) Paper Pressing Device 400

As shown in FIGS. 1 and 2, the paper pressing device 400 is disposed in a position spaced by a distance corresponding to the length of an individual sheet J from the downstream end of the carrying surface of the first conveyor 200 for engagement with the individual upper surfaces of the flat belts 301 traveling over the guide plate 307 of the second conveyor 300.

As shown in FIGS. 5 and 6, a shaft 401 of the paper pressing device 400, which shaft is pivotably supported at its opposite ends by the two frames Fa, Fb, is disposed above the second conveyor 300 with one shaft end 401a projecting outward from the corresponding frame Fb.

Two collars 413, 413a are fixedly mounted on the shaft 401 at the respective inner surfaces of the two frames Fa, Fb, for restricting the axial movement of the shaft 401. A plurality of pairs of arms 403, 404, one pair corresponding to each of the flat belts 301 of the second conveyor 300, are attached at their base ends to the shaft 401 in such a manner that the base ends of the arms 403, 404 are in mutual contact in the axial direction and that the arm 403 is pivotable with respect to the shaft 401, while the arm 404 pivots together with the shaft 401.

Further, in order to restrict the axial movement of the pairs of arms 403, 404, a plurality of collars 411 are fixedly attached to the shaft 401 to be located between adjacent pairs, and two collars 412, 412a are attached to the shaft 401 at opposite ends of the series of pairs of the arms 403, 404.

A pulley 402 is rotatably supported by the distal end of each of the arms 403. The pulley 402 has a circumferential surface to be engaged with the upper surface of the corresponding flat belt 301 of the second conveyor 300.

A block 405 is pivotably mounted on a side surface of the distal end of each of the arms 404. One end of a rod 406 is pivotably attached to a central portion of the arm 403; and the other end of the rod 406 extends through the block 405. Further, a compression spring 407 is provided on the rod 406 to be located between the block 405 and an unnumbered flange provided at a central portion of the rod 406.

A stopper 406a, such as a nut, is mounted on the other end of the rod 406 extending through the block 405, in order to prevent removal of the rod 406 from the block 405.

Accordingly, under the spring force of the compression spring 407 acting between the arms 403, 404, the pulley 402 supported by the arm 403 is urged to press a sheet F being conveyed on the flat belts 301 of the second conveyor 300, downward toward the second conveyor 300 by a predetermined amount of pressure.

At this time, because the guide plate 307 is disposed under the flat belts 301, the flat belts 301 are prevented from being displaced downward under the pressing force of the pulley 402.

The arm 403 and the pulley 402 are located in a position such as not to engage with the flat belts 201 of the upper conveyor 200a of the first conveyor 200.

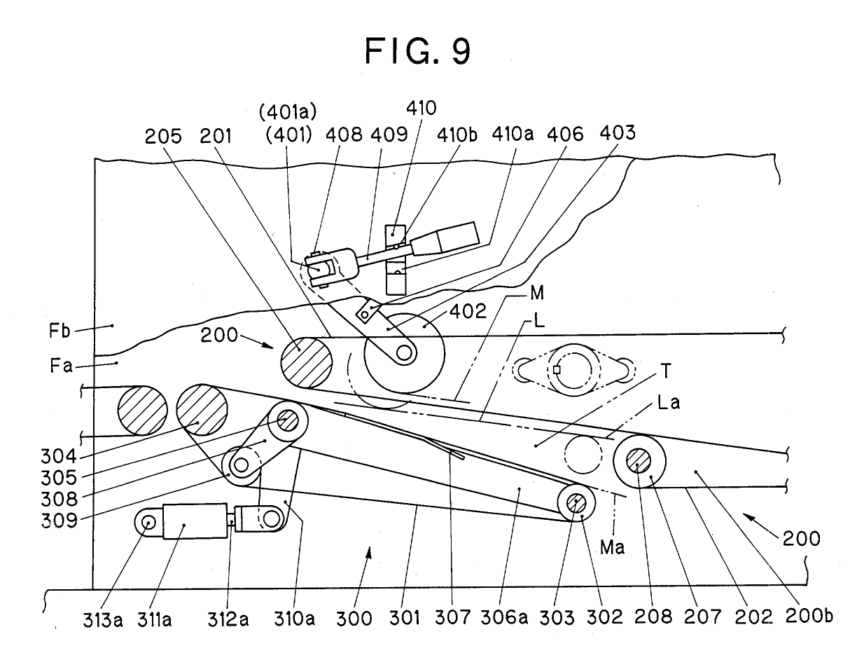

As shown in FIGS. 6 and 9, the end portion 401a of the shaft 401 projecting outward from the frame Fb has on its circumferential surface two parallel flat portions; and the bifurcated end of a handle 409 is attached to the end portion 401a of the shaft 401 by a radial pin 408 in such a manner that the parallel inside walls of the bifurcated end sandwich the two parallel flat portions. This structure enables the handle 409 to pivot about the pin 408 with respect to the shaft 401.

Further, a block 410 is attached to an outer surface of the frame Fb. The block 410 has first and second grooves 410a, 410b for holding a central portion of the handle 409 selectively in an operative position L in which the pulley 402 is on the flat belts 301 or a standby position M in which the pulley 402 is retracted upward from the flat belts 301.

(e) Pushing Down Device 500

As shown in FIGS. 1 and 2, the pushing down device 500 is disposed adjacent to and above the upstream end of the second conveyor 300 and upstream of the paper pressing device 400.

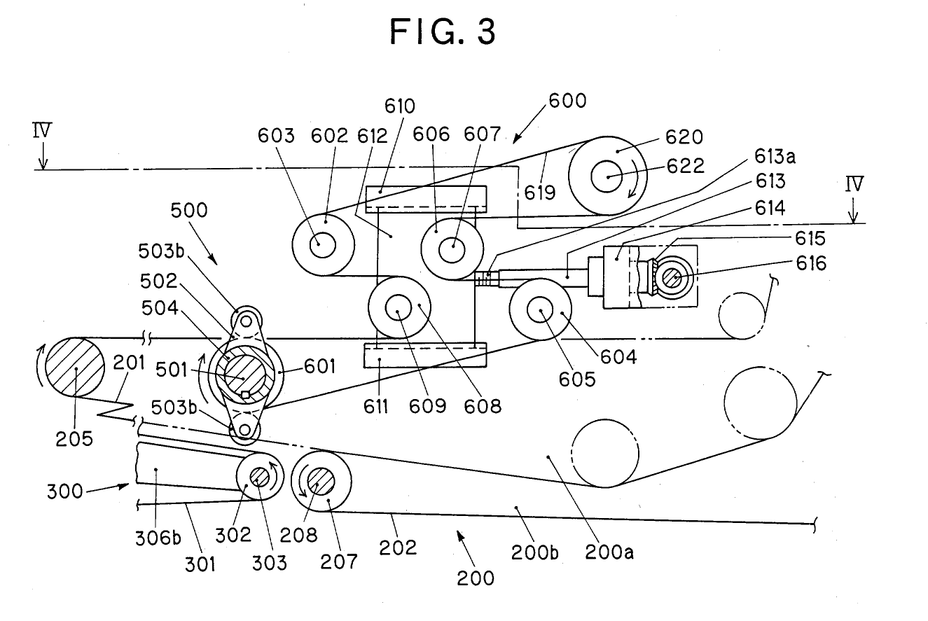

As shown in FIGS. 3 and 4, in a position above the roller 302 of the second conveyor 300, a follower shaft 501 having a key groove is rotatably supported by the two frames Fa, Fb.

An alternating series of arms 502 and collars 504 are attached to the follower shaft 501 by means of keys fitted in the key groove of the follower shaft 501, being sandwiched between a pair of end collars 505, 505. The collars 504 separate adjacent arms 502 by a predetermined distance corresponding to that between the flat belts 201 of the upper conveyor 200a in such a manner that the arms 502 are arranged so as to be staggered with respect to the flat belts 201.

Each of the arms 502 has a boss portion attached to the follower shaft 501, and a pair of diametrically opposite arm portions identical in length and projecting radially outward from the boss portion. A pair of small rollers 503a, 503b are rotatably attached to the distal ends of the arm portions.

The small rollers 503a, 503b of each arm 502 can pass through the space between the adjacent flat belts 201 of the upper conveyor 200a of the first conveyor 200 without interference with the flat belts 201 while the follower shaft 501 is rotating. The circumferential surface of each of the small rollers 503a, 503b faces the upper surface of the flat belts 301 of the second conveyor 300 with a small gap therebetween.

Further, a follower pulley 601 of a phase adjustment mechanism 600, which will be described later, is mounted on the follower shaft 501 at a position between the frame Fa and one end of the alternating series of the arms 502 and collars 504.

(f) Phase Adjustment Mechanism 600

In order to synchronize the timing when the pushing down device 500 pushes a sheet J downward with the timing when a trailing end portion of the sheet J moves from the first conveyor 200 to the second conveyor 300, as shown in FIGS. 3 and 4, the sheet delivery apparatus is equipped with the phase adjustment mechanism 600, which adjusts the phase of the pushing down device 500.

As shown in FIGS. 3 and 4, the phase adjustment mechanism 600 includes a pin 603 projecting from the inner surface of the frame Fa at a position above the follower shaft 501 of the pushing down device 500. An intermediate pulley 602 is rotatably attached to the distal end of the pin 603.

Rightward of the intermediate pulley 602, a pair of parallel spaced guides 610, 611 are attached to the inner surface of the frame Fa, between which a slider 612 is mounted for movement in the right-left direction; i.e., horizontally.

Further, as shown in FIG. 4, an L-shaped bracket 614 is mounted on the inner surface of the frame Fa. The L-shaped bracket 614 is located rightward of the slider 612 and has a first leg extending perpendicular to the frame Fa and terminating in a distal end attached to the inner surface of the frame Fa, and a second leg extending rightward in parallel to the frame Fa.

A screw shaft 613, which has a male thread 613a formed on its left end portion and a bevel gear 615 mounted on its right end portion, is rotatably supported by the first leg of the L-shaped bracket 614. The male-thread portion 613a is threadedly fitted in a female-thread hole 612a opened to the right side surface of the slider 612.

A shaft 617, which extends perpendicular to the frames Fa, Fb, has a first end portion rotatably supported by the second leg of the L-shaped bracket 614 and a second end portion rotatably supported by the frame Fb. A bevel gear 616 in meshing engagement with the bevel gear 615 is attached to the end that projects from the bracket 614; and an adjusting knob 618 is attached to the end that projects from the frame Fb.

As shown in FIG. 3, a pair of pins 607, 609 are mounted on the slider 612 at its inner surface facing the frame Fb, and are spaced from each other in the up-down and right-left directions. A pair of moving pulleys 606, 608 are rotatably mounted on the respective distal ends of the two pins 607, 609.

At a position below the screw shaft 613, a pin 605 is mounted on the inner surface of the frame Fa perpendicular thereto, and a toothed intermediate pulley 604 is rotatably attached to the distal end of the pin 605.

A drive shaft 622 to be driven by an unillustrated drive unit is rotatably supported by the frame Fa at a position above the screw shaft 613. The distal end of the drive shaft 622 projects inward from the frame Fa; and the toothed drive pulley 620 is attached to the distal end of the drive shaft 622.

A toothed endless belt 619 is wound around the drive pulley 620, the moving pulley 606, the intermediate pulley 604, the follower pulley 601, the moving pulley 608, and the intermediate pulley 602. The drive shaft 622 is driven by the unillustrated drive unit in such a manner that the ratio of the traveling speed of the toothed belt 619 to the belt traveling speed of the upper and lower conveyors 200a, 200b of the first conveyor 200 is maintained constant.

The operation of the thus-constructed sheet delivery apparatus of the sheet folding machine will now be described.

(1) As shown in FIG. 1, in the rotary printing press, a continuous paper web P traveling through a printing unit (not shown) is folded in half along the longitudinal center line by the former B, and the two-fold continuous paper web P is drawn by the co-acting nipping rollers C. Then, the continuous paper web P traveling along the paper web path branch H via the guide roller I is forwarded to the cutter mechanism 100.

As shown in FIG. 2, the continuous paper web P being fed by the pair of paper web feed rollers 101 of the cutter mechanism 100 and passing through the gap between the pair of cutting drums 102 is cut into sheets J of predetermined length each time the cutter blade 103a (or 103b) of the cutter-blade carrying drum 103 bites into the cutting shoulder 104a (or 104b) of the cutting-shoulder carrying drum 104 upon every half rotation of the two cutting drums 102.

When the leading end of a sheet J cut off the continuous paper web P is nipped by the upper and lower conveyors 200a, 200b of the first conveyor 200 at a position immediately upstream of the meeting point of the flat belts 201 of the upper conveyor 200a and the flat belts 202 of the lower conveyor 200b and simultaneously with or slightly after the cutting, the trailing end of the same sheet J is separated from the leading end of the continuous paper web P, because the conveying speed of the first conveyor 200 is slightly faster than the speed at which the continuous paper web P is fed by the cutter mechanism 100. As a result, the successive cut sheets J are conveyed with spaces therebetween by the first conveyor 200.

This conveying of each sheet J by the first conveyor 200 continues until the trailing end of the sheet J is released from the nipping by the upper and lower conveyors 200a, 200b; i.e., until the leading end of the sheet J comes into engagement with the paper pressing device 400, which is spaced downstream from the downstream end of the carrying surface of the first conveyor 200 by a distance corresponding to the length of the sheet J, as measured along the sheet path.

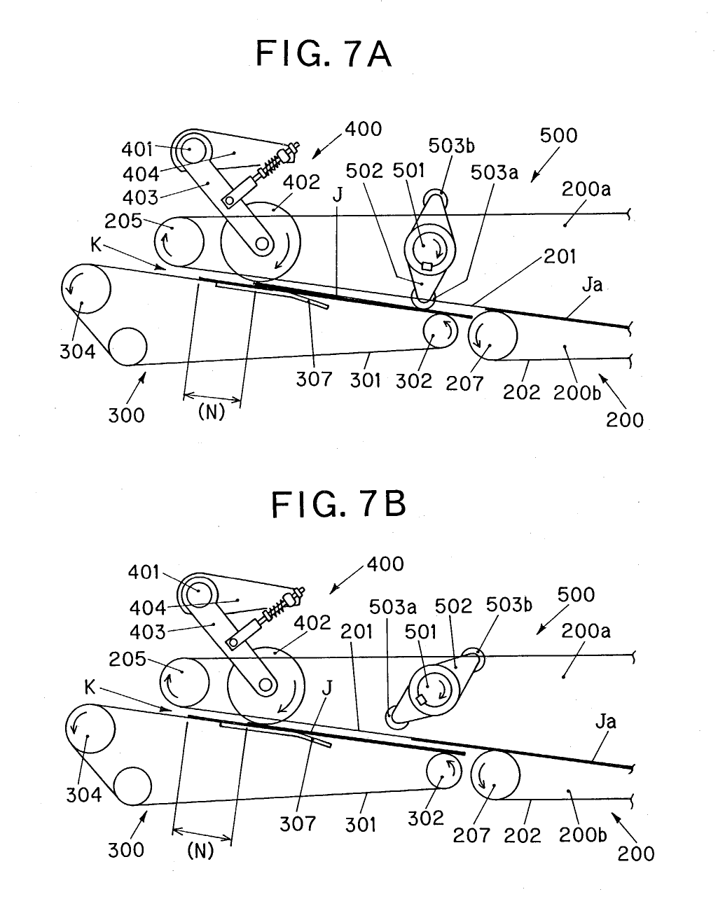

(2) Subsequently, as shown in FIG. 7A, the successive sheets J being conveyed by the first conveyor 200 with the timing of receipt from the cutter mechanism 100 are transferred onto the second conveyor 300. The leading end of the sheet J being transferred from the first conveyor 200 onto the second conveyor 300 is pressed downward against the flat belts 301 by the pulleys 402 of the paper pressing device 400 and is conveyed forward along the sheet path with the movement of the flat belts 301.

The follower shaft 501 of the pushing down device 500 is driven for rotation at the same rpm (revolutions per minute) as the cutter drums 102 in such a manner that the pushing down device 500 acts on each sheet J being transferred from the first conveyor 200 to the second conveyor 300. That is, the follower shaft 501 makes a half rotation for every sheet J being transferred from the first conveyor 200 to the second conveyor 300.

Therefore, the small rollers 503a (or 503b) of the arms 502, whose rotational phases are adjusted in such a manner that the circumferential surfaces of the small rollers 503a (or 503b) engage with the upper side of the trailing end portion of the sheet J at a proper position, pushes, as if by striking, the trailing end portion of the sheet J downward against the carrying surface of the second conveyor 300, whose level is lower than the downstream end portion of the carrying surface of the first conveyor 200, at a position spaced a suitable distance downstream from the rollers 302.

When the trailing end portion of the preceding sheet J is thus pushed downward by the small rollers 503a, the leading end portion of the succeeding sheet Ja is on the roller 207 of the lower conveyor 200b of the first conveyor 200.

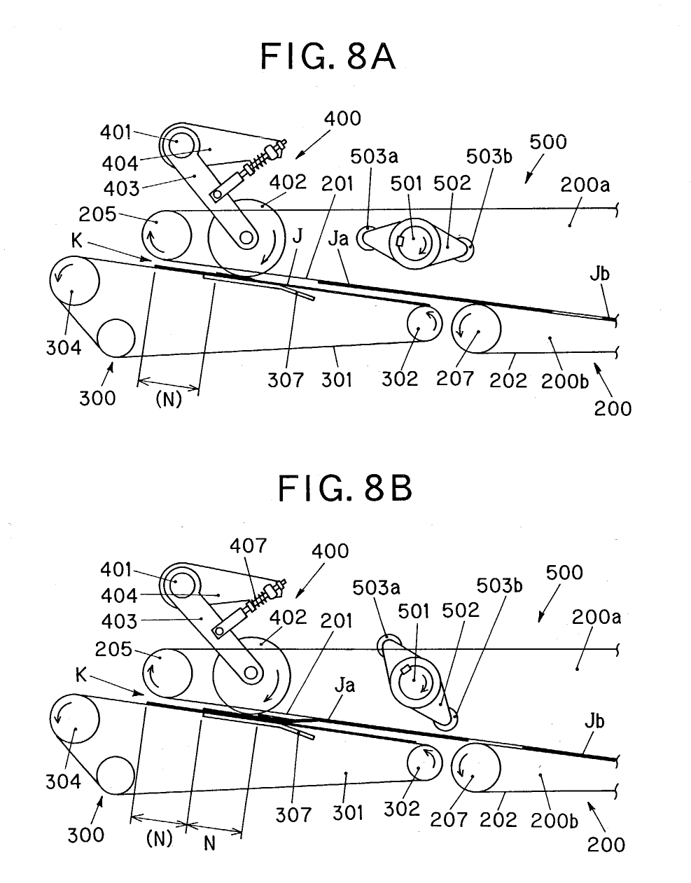

Then, as shown in FIGS. 7B and 8A, when the succeeding sheet Ja is transferred by the first conveyor 200 toward the second conveyor 300, the leading end portion of the succeeding sheet Ja is placed over the trailing end portion of the preceding sheet J being conveyed by the second conveyor 300 while being pushed against the carrying surface of the second conveyor 300, because the conveying speed of the second conveyor 300 is slower than that of the first conveyor 200 by a predetermined ratio.

At that time, since the trailing end portion of the preceding sheet J is pushed downward against the carrying surface of the second conveyor 300 by the small rollers 503a of the pushing down device 500 before the succeeding sheet J arrives at the second conveyor 300, the leading end portion of the succeeding sheet Ja is free from either engaging with or entering under the trailing end portion of the preceding sheet J.

Further, before start of conveyance of the successive sheets J with the leading end portion of the succeeding sheet Ja overlapping the trailing end portion of the preceding sheet J, the leading end portion of the preceding sheet J comes under the pulleys 402 of the paper pressing device 400 and is pressed toward the second conveyor 300 by the pressure of the pulleys 402. Therefore, the preceding sheet J is free from being pushed forward or bent by the succeeding sheet Ja being advanced, thereby avoiding irregular variation of the pitch of overlapping of the successive sheets J.

(3) As shown in FIGS. 7B and 8A, when the leading end portion of the succeeding sheet Ja comes above the second conveyor 300 as the succeeding sheet Ja is conveyed further by the first conveyor 200, the pushing down device 500 rotates, whereby the small rollers 503a of the pushing down device 500 move from the flat belts 301 of the second conveyor 300 downstream and upward of the lower portions of the flat belts 201 of the upper conveyor 200a, to thereby move away from the succeeding sheet Ja.

Accordingly, the leading end portion of the succeeding sheet Ja is prevented from engaging with the moving small roller 503a.

Subsequently, the small rollers 503b, which are spaced 180 degrees in phase from the small rollers 503a about the follower shaft 501, are moved downward to a position above the lower portions of the flat belts 201 of the upper conveyor 200a.

(4) When a demand arises to adjust the position in which the small rollers 503a or 503b engage with the sheet J, Ja . . . during operation of the sheet delivery apparatus, the operator changes the rotational phases of the arms 502 by means of turning the adjusting knob 618 by hand.

As shown in FIGS. 3 and 4, when the adjusting knob 618 is thus turned, the screw shaft 613 is rotated via the bevel gears 615, 616 so as to move the slider 612 rightward or leftward so that the moving pulleys 606, 608 are moved in the same direction.

For example, advancing the phase of rotation of the arms 502 are achieved by temporarily increasing the moving speed of the toothed belt 619 running from the intermediate pulley 604 to the moving pulley 608 via the follower pulley 601, to thereby increase the travel distance of the toothed belt 619 during that period; namely, by displacing the slider 612 rightward in FIG. 3.

In contrast, delaying the phase of rotation of the arms 502 is achieved by temporarily reducing the moving speed of the toothed belt 619; namely, by displacing the slider 612 leftward in FIG. 3.

If the position and/or timing of the first conveyor 200 which nips the leading end portion of the sheet J varies as a result of variations in thickness and/or quality of the sheet J cut by the cutter mechanism 100, the position in which the small rollers 503a or 503b act on the sheet J being conveyed by the first conveyor 200 possibly slides off the correct position and, in such event, that position can be corrected by the above-mentioned adjusting operation of the phase adjustment mechanism 600 during operation of the sheet delivery apparatus.

(5) As shown in FIG. 8B, with continued conveying of the succeeding sheet Ja, its trailing end portion is released from the first conveyor 200 and, at the same time, its leading end portion strikes the circumferential surfaces of the pulleys 402 of the paper pressing device 400 and soon enters under the pulleys 402. Then, as the pulleys 402 rotate, the leading end portion of the succeeding sheet Ja is placed over the preceding sheet J at a predetermined pitch N and is sandwiched between the preceding sheet J and the pulleys 402 normally biased downward by the resilient force of the compression springs 407. Therefore, the preceding sheet J and the succeeding sheet Ja are conveyed at the conveying speed of the second conveyor 300 without sliding on each other.

(6) Namely, as shown in FIG. 8B, the preceding and succeeding sheets J, Ja are conveyed by the second conveyor 300 in a uniform scale-like arrangement in which the succeeding sheet Ja partially overlaps the preceding sheet J by the distance of the predetermined pitch N.

Subsequently, when the trailing end portion of the succeeding sheet Ja is advanced past the downstream end of the first conveyor 200, like the case of the preceding sheet J (FIG. 7A), the circumferential surfaces of the small rollers 503b of the pushing down device 500 engage with the upper side of the trailing end portion of the succeeding sheet Ja and push the trailing end of the succeeding sheet Ja downward against the second conveyor 300. This operation secures a space for enabling advancement, toward the second conveyor 300, of the leading end portion of another succeeding sheet Jb that is transferred at the conveying speed of the first conveyor 200.

By repeating the foregoing operations in the described sequence, the successive sheets J, Ja, Jb . . . are transferred from the first conveyor 200 onto the second conveyor 300 to form a sheet train K on the second conveyor 300.

(7) To remove a sheet or sheets jammed between the second conveyor 300 and the upper conveyor 200a of the first conveyor 200 during the foregoing operations or to perform maintenance and adjustment of the sheet delivery apparatus, the operator first stops the operation of the sheet folding machine, then turns a switch for an unillustrated solenoid valve in order to retract the rods 312, 312a of the hydraulic cylinders 311, 311a of the second conveyor 300 to thereby move the rollers 302 from their operative position La to their standby position Ma, and finally lowers the carrying surface of the second conveyor 300.

Further, when the operator pulls toward himself the handle 409 held in the first groove 410a of the block 410 of the paper pressing device 400 (downward in FIG. 6) in order to remove the handle 409 off the first groove 410a, and then raises the handle 409 and pushes it toward the block 410 so as to insert the handle 409 in the second groove 410b of the block 410, the shaft 401 can be displaced angularly and hence the pulleys 402 connected to the shaft 401 can be shifted from its operative position L to its standby position M retracted upward from the flat belts 201, thus forming a space T sufficiently large for the operator to remove the jammed sheet or sheets by hand or to carry out maintenance and adjustment work.

According to the sheet delivery apparatus of the present invention, when sheets successively cut off a continuous length paper web by the cutting drums are conveyed in a scale-like arrangement, in which a succeeding sheet partially overlaps a preceding sheet, by means of conveyors, irregular variation of the pitch of overlapping of the successive sheets arranged in a scale-like train can be prevented, thus guaranteeing high-quality printed products.

Further, because the sheet delivery apparatus of the present invention is simple in mechanical construction, the operator's labor for maintenance and inspection work is minimized, and the apparatus can be made compact to thereby enhance space savings.

It is to be noted that the present invention is not limited to the illustrated embodiment, and various changes or modifications may be suggested without departing from the gist and scope of the subject matter as defined in the appended claims.

What is claimed is:

1. A sheet delivery apparatus comprising:
a cutter mechanism for cutting a continuous paper web traveling in a paper web path transversely into sheets of a predetermined length;
a first conveyor disposed downstream of said cutter mechanism and adapted to convey the sheets successively with spaces therebetween;
a second conveyor disposed adjacent to and downstream of said first conveyor and having a carrying surface lower in level than the carrying surface of said first conveyor, said second conveyor receiving the sheets transferred successively from said first conveyor and conveying the sheets at a conveying speed lower than that of said first conveyor after arranging the sheets in a scale-like train in which a succeeding sheet partially overlaps a preceding sheet;
a pushing down device disposed adjacent to an upstream end of said second conveyor and adapted to push downward against said second conveyor a trailing end portion of the individual sheet being transferred from said first conveyor to said second conveyor; and
a paper pressing device disposed above said second conveyor so as to face the carrying surface thereof in a position spaced from a downstream end of the carrying surface of said first conveyor by a distance substantially equal to the predetermined length of the sheet, said paper pressing device guiding a leading end portion of the succeeding sheet transferred from said first conveyor to said second conveyor and pressing downward the leading end portion of the succeeding sheet overlapping the preceding sheet carried on the carrying surface of said second conveyor.

2. A sheet delivery apparatus according to claim 1, wherein said pushing down device is a revolving member whose phase of rotation is adjustable by a phase adjustment mechanism.

3. A sheet delivery apparatus according to claim 1, wherein said paper pressing device is a pulley facing a guide plate with a belt of said second conveyor interposed therebetween.

4. A sheet delivery apparatus according to claim 2, wherein said paper pressing device is a pulley facing a guide plate with a belt of said second conveyor interposed therebetween.
